(19) United States
(12) Patent Application Publication
(10) Pub. No.: US 2008/0081677 A1
(43) Pub. Date: Apr. 3, 2008

(54) Mobile phone capable of injecting/ejecting SIM card

(75) Inventor: Yaw-Huey Lai, Taipei County (TW)

Correspondence Address: BACON & THOMAS, PLLC, 625 SLATERS LANE, FOURTH FLOOR, ALEXANDRIA, VA, 22314, US

(73) Assignee: TAI-SOL ELECTRONICS CO., LTD., TAIPEI CITY (TW)

(21) Appl. No.: 11/655,078

(22) Filed: Jan. 19, 2007

(30) Foreign Application Priority Data
Sep. 29, 2006 (TW) 95217486

(51) Int. Cl. H04M 1/00

(52) U.S. Cl. 455/575.1

(57) ABSTRACT

A mobile phone capable of injecting/ejecting a SIM card includes a main body and a SIM card connector. The main body includes a housing, a display screen, a plurality of keypads, a circuit module, and an antenna. The housing has a SIM slot. The SIM card connector is mounted in the housing, having a shell, a plurality of terminals mounted in the shell and connected with the circuit module, an opening formed at the shell and corresponding to the SIM slot, and an injecting/ejecting device having a linear cam, a spring, a positioning member, and a heart-shaped groove formed at the linear cam. In light of this, the mobile phone allows the user to change the SIM card externally without opening the housing of the mobile phone, thus being very convenient for the changeover of the SIM card.

### BACKGROUND OF THE INVENTION

1. Field of the Invention

The present invention relates generally to mobile phones, and more particularly, to a mobile phone capable of injecting/ejecting a subscriber identity module (SIM) card.

2. Description of the Related Art

When a user intends to operate a current common mobile phone to communicate with people, the user has to apply for a mobile phone number to own a SIM card recorded with relevant information regarding the phone number and then insert the SIM card into the mobile phone to enable the phone communication. Therefore, the SIM card is quite significant. To prevent the SIM card from accidental disengagement or slipperiness from the mobile phone, as shown in FIG. 8, a conventional mobile phone 70 includes a receiving recession located under a battery 72 for receiving a SIM card 79. After the battery 72 is installed, the SIM card 79 can be held in the receiving recession by the battery 79, thus failing to slip away from the mobile phone 70.

However, more and more people go traveling for a long way or take business trips in foreign countries and they may have to change the original SIM card to the one that the user applies in the current country or region to avoid unnecessary international telephone call costs. When changing the SIM card, if the user uses the above-mentioned mobile phone, the user will has to remove the rear cover of the mobile phone first, take the battery and the SIM card out of it, then install the new SIM card, and finally reposition the battery and the rear cover. It is very inconvenient and troublesome to change the SIM card. Further, it is difficult to remove the rear cover of some mobile phone and the user has to be skillful to successfully remove the rear cover. In light of this, there is still some space for improvement of the inconvenience of the changing the SIM card.

In addition, FIG. 9 illustrates a conventional card connector having a housing 81 and an injecting/ejecting device 83 mounted in the housing 81 for the user's operation. After a card is pushed into the card connector, the injecting/ejecting device 83 can position the card in the operational location. When the user pushes the card again, the injecting/ejecting device 83 can push the card to the ejecting position.

### SUMMARY OF THE INVENTION

The primary objective of the present invention is to provide a mobile phone capable of injecting/ejecting a SIM card, which allows the user to directly change the SIM card externally without uncapping the mobile phone to be very convenient.

The foregoing objective of the present invention is attained by the mobile phone composed of a main body and a SIM card connector. The main body includes a housing, a display screen, a plurality of keypads, a circuit module, and an antenna. The housing has a SIM slot. The SIM card connector is mounted in the housing, having a shell, a plurality of terminals mounted in the shell and connected with the circuit module, an opening formed at the shell and corresponding to the SIM slot, and an injecting/ejecting device having a linear cam, a spring, a positioning member, and a heart-shaped groove formed at the linear cam. In light of this, the present invention allows the user to change the SIM card externally without opening the housing of the mobile phone, thus being very convenient for the changeover of the SIM card.

### BRIEF DESCRIPTION OF THE DRAWINGS

FIG. 1 is a perspective view of a preferred embodiment of the present invention.

FIG. 2 is a perspective rear view of the preferred embodiment of the present invention.

FIG. 3 is a perspective exploded view of the preferred embodiment of the present invention.

FIG. 4 is a schematic view of the first preferred embodiment of the present invention, illustrating the assembly of the mobile phone and the SIM card connector.

FIG. 5 is a partial exploded view of the preferred embodiment of the present invention, illustrating the internal structure of the SIM card connector.

FIG. 6 is similar to FIG. 2, illustrating a SIM card is initially inserted therein.

FIG. 7 is similar to FIG. 2, illustrating the SIM card is fully inserted therein.

FIG. 8 shows a conventional mobile phone that a SIM card is being installed.

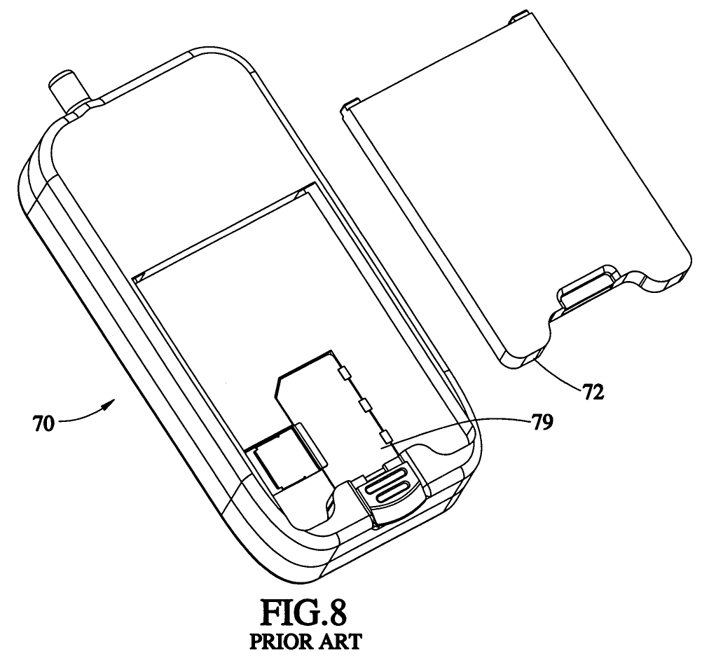

FIG. 9 shows a conventional card connector.

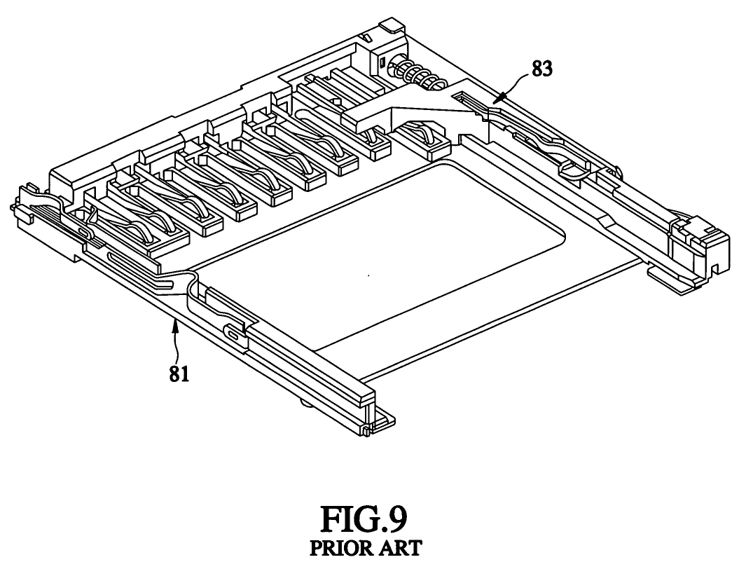

### DETAILED DESCRIPTION OF PREFERRED EMBODIMENTS

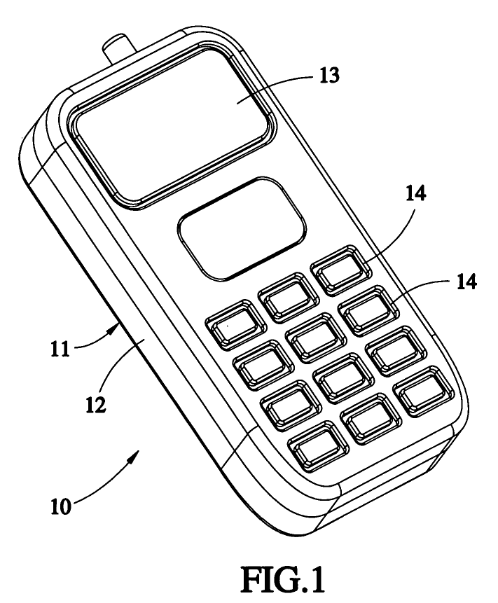

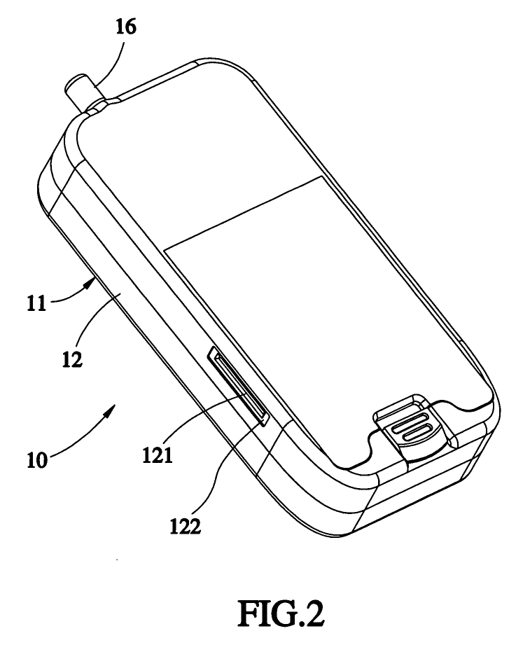

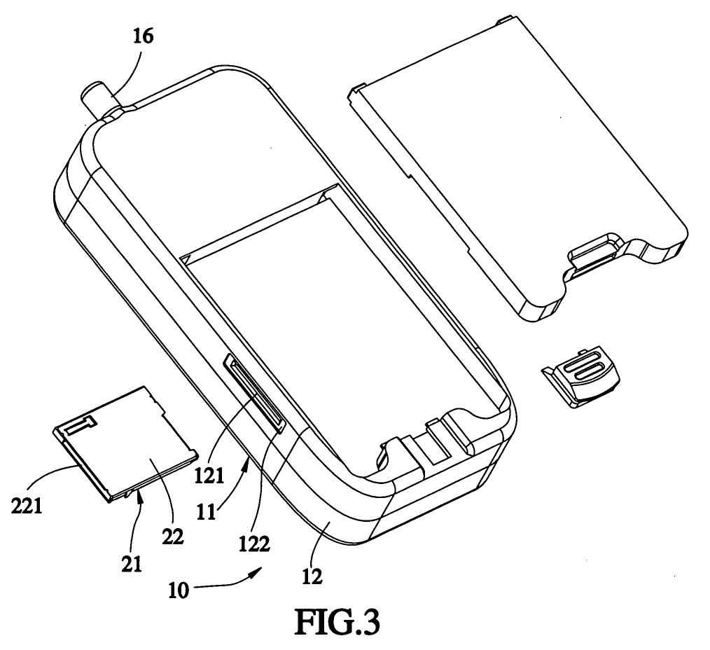

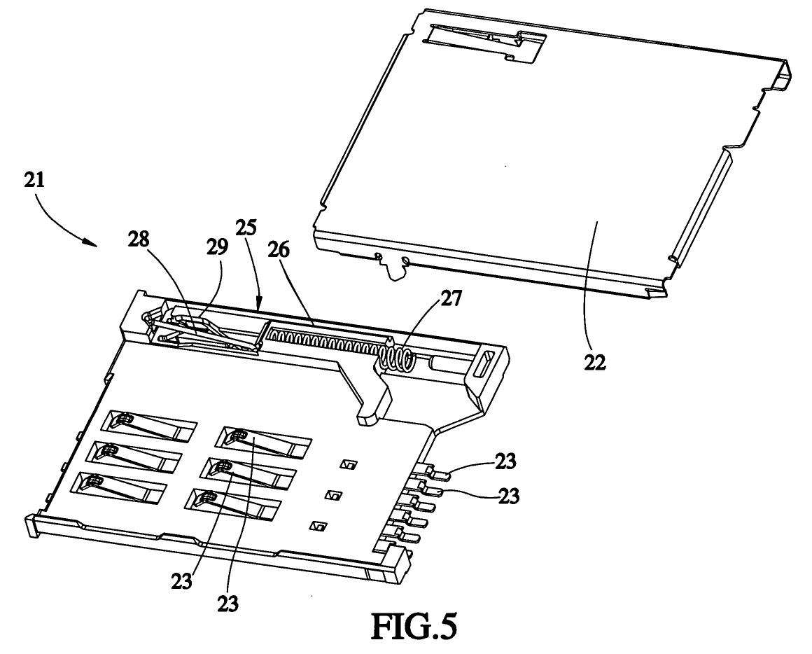

Referring to FIGS. 1-6, a mobile phone 10 constructed according to a preferred embodiment of the present invention is composed of a main body 11 and a SIM card connector 21.

The main body 11 includes a housing 12, a display screen 13, a plurality of keypads 14, a circuit module 15, and an antenna 16. The circuit module 15 is a circuit board in this embodiment. Since the other elements have been widely taught in various kinds of the mobile phones, no detailed description is necessary. The feature of the present invention lies in that the housing 12 has a SIM slot 121 formed at a predetermined position thereof. In this embodiment, the SIM slot 121 is located at a lateral side of the housing 12.

The SIM card connector 21 is mounted in the housing 23. The SIM card connector 21 includes a shell 22, a plurality of terminals 23, and an injecting/ejecting device 25. The terminals 23 are mounted in the shell 22 and connected with the circuit module 15, for corresponding connection with the inserted SIM card 91. The housing 22 has an opening 221 right corresponding to the SIM slot 121. The injecting/ejecting device 21 has a linear cam 26, a spring 27, a positioning member 28, and a heart-shaped groove 29 formed at the linear cam 26. Since the injecting/ejecting device 21 has been widely taught in the conventional card connectors and exemplified in the above-mentioned column of Description of the Related Art, no more description of its detailed structure and the interactive relationships among its elements.

In this embodiment, a stepped portion 122 is formed around the SIM slot 121 for allowing the user's finger to push the SIM card 91 further inward after the SIM card 91 is inserted into the SIM card connector 21. In addition, the inserted SIM card 91 does not protrude out of the surface of the housing 12. After inserted, the outer fringe of the SIM card 91 is aligned with the surface of the stepped portion 122 or alternatively, the outer fringe of the SIM card 91 protrudes slightly out of the surface of the stepped portion 122 and be aligned with the surface of the housing 12.

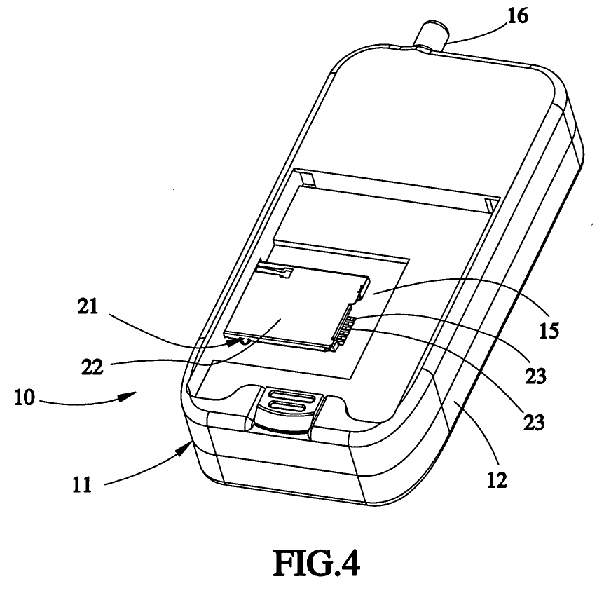

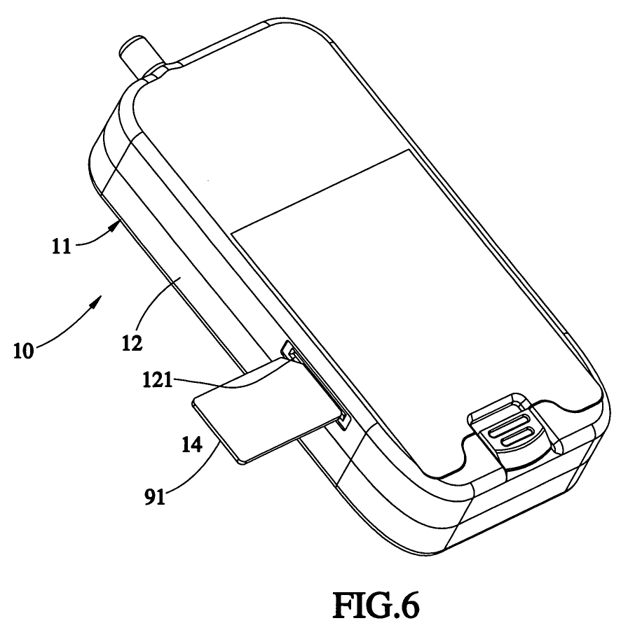

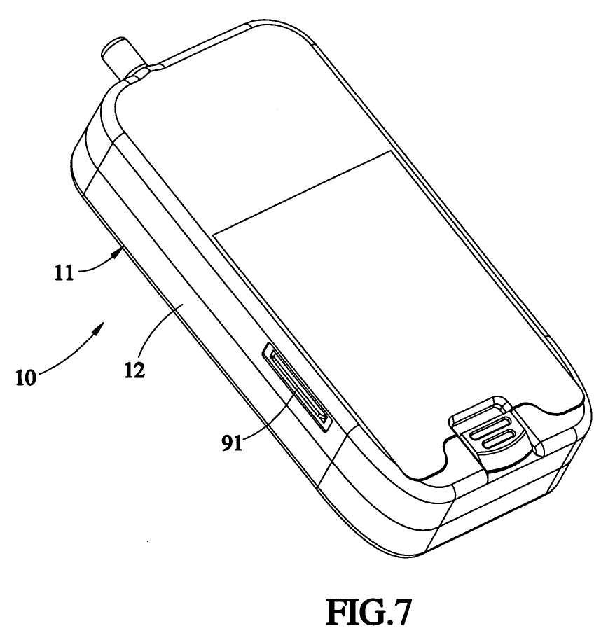

Please refer to FIG. 4 illustrating the present invention before the SIM card is inserted therein. As shown in FIGS. 6 and 7, while inserting the SIM card 91, align the SIM card 91 with the SIM slot 121 and then insert the SIM card 91 into the SIM slot 121; meanwhile, the injecting/ejecting device 25 can position the SIM card 91 after the SIM card 91 is located at an insertion position that the SIM card 91 is connected with the mobile phone. When the user intends to take the SIM card 91 out, the user can nothing but push the SIM card 91 once to enable the injecting/ejecting device 25 to eject the card for a predetermined length can the user can take it out. In light of this, while changing the SIM card, the user could only inject/eject the card from the lateral side of the mobile phone.

As known from above, the present invention allows the user to do the changeover of the SIM card at the external side of the mobile phone and it is not necessary to dismantle the mobile phone or remove its cover, thus being very convenient for the changeover.

Although the present invention has been described with respect to a specific preferred embodiment thereof, it is no way limited to the details of the illustrated structures but changes and modifications may be made within the scope of the appended claims.

What is claimed is:

1. A mobile phone capable of injecting/ejecting a SIM card, comprising:
a main body having a housing, a display screen, a plurality of keypads, a circuit module, and an antenna, said housing having a SIM slot formed at a predetermined position thereof; and
a SIM card connector mounted in said housing and having a shell, a plurality of terminals mounted in said shell electrically connected with said circuit module, an opening right corresponding to said SIM slot, and an injecting/ejecting device, said injecting/ejecting device having a linear cam, a spring, a positioning member, and a heart-shaped groove formed on said linear cam.

2. The mobile phone as defined in claim 1, wherein said housing further comprises a stepped portion formed around said SIM slot.

3. The mobile phone as defined in claim 1, wherein said SIM card has an outer fringe which does not protrude out of a surface of said housing.

4. The mobile phone as defined in claim 1, wherein said SIM slot is located at a lateral side of said housing.
